(19) United States
(12) Patent Application Publication
(10) Pub. No.: US 2017/0305425 A1
(43) Pub. Date: Oct. 26, 2017

(54) DRIVERLESS VEHICLE, DRIVERLESS VEHICLE CONTROL METHOD AND DRIVERLESS VEHICLE CONTROL APPARATUS

(71) Applicant: Baidu Online Network Technology (Beijing) Co., Ltd., Beijing (CN)

(72) Inventor: Liang XING, Beijing (CN)

(21) Appl. No.: 15/283,099

(22) Filed: Sep. 30, 2016

(30) Foreign Application Priority Data
Apr. 26, 2016 (CN) 201610267014.9

(51) Int. Cl. B60W 30/182; B60W 50/10; G05D 1/00

(52) U.S. Cl. CPC B60W 30/182; G05D 1/0088; B60W 50/10; B60W 2420/24; B60W 2900/00

(57) ABSTRACT

The present application discloses a driverless vehicle, a driverless vehicle control method and a driverless vehicle control apparatus. The vehicle includes: a steering wheel and a processor. A sensor is provided on the steering wheel. The processor is configured to switch a driving mode of the driverless vehicle to a manual driving mode in response to detecting a sensing signal outputted by the sensor, when the driverless vehicle is in an autonomous driving mode. This implementation achieves smooth switching of the driving mode.

### CROSS-REFERENCE TO RELATED APPLICATIONS

This application is related to and claims priority from Chinese Application No. 201610267014.9, filed on Apr. 26, 2016, entitled “DRIVERLESS VEHICLE, DRIVERLESS VEHICLE CONTROL METHOD AND DRIVERLESS VEHICLE CONTROL APPARATUS”, the entire disclosure of which is hereby incorporated by reference.

### TECHNICAL FIELD

The present application relates to the field of vehicle technology, specifically to the field of intelligent car technology, and more specifically to a driverless vehicle.

### BACKGROUND

Although the autonomous vehicle driving technology is currently becoming more mature, there are scenarios where it is necessary that the autonomous driving system exits the control of the vehicle, and a human driver takes over the vehicle. In this case, there is a need for a rapid and reliable method for switching the vehicle driving modes.

However, all existing autonomous driving exit mechanisms, such as exiting autonomous driving by turning the steering wheel or stepping on the gas pedal or the brake pedal, require a change of the vehicle traveling status, and cannot achieve a convenient and smooth exit. Therefore, it is necessary to improve the smoothness of the vehicle operating state when the autonomous driving exit mechanism of the vehicle is triggered.

### SUMMARY

An objective of some embodiments of the present application is to provide an improved driverless vehicle, and a driverless vehicle control method and apparatus, so as to solve the technical problem mentioned in the Background section.

According to a first aspect, some embodiments of the present application provide a driverless vehicle, which comprises a steering wheel; a processor; and a sensor provided on the steering wheel; and the processor configured to switch a driving mode of the driverless vehicle to a manual driving mode in response to detecting a sensing signal output by the sensor, when the driverless vehicle is in an autonomous driving mode.

In some embodiments, the processor is configured to: switch the driving mode of the driverless vehicle to the autonomous driving mode in response to that no sensing signal output by the sensor is detected, when the driverless vehicle is in the manual driving mode.

In some embodiments, the sensor the sensor comprises at least one of the following: a capacitive sensor for detecting a contact between an object and the steering wheel, and outputting a sensing signal indicating that the contact between the object and the steering wheel if affirmative; a tactile switch for detecting an object pressing the steering wheel, and outputting a sensing signal indicating the object pressing the steering wheel if affirmative; a proximity switch for detecting an object approaching the steering wheel, and outputting a sensing signal indicating that the object approaching the steering wheel if affirmative; and a pressure sensor for detecting an object pressing the steering wheel, outputting a sensing signal indicating that the object pressing the steering wheel, and detecting and outputting magnitude of a pressure exerted by the object on the steering wheel.

In some embodiments, the capacitive sensor comprises: an insulated flexible printed circuit board covering an inner surface of an annular body of the steering wheel, and an electrostatic capacitance detecting electrode disposed on a surface of the flexible printed circuit board.

In some embodiments, the pressure sensor comprises: an insulated flexible printed circuit board covering an inner surface of an annular body of the steering wheel, and a pressure sensitive material disposed on a surface of the flexible printed circuit board.

In some embodiments, when the sensor is a pressure sensor, the processor is configure to: switch the driving mode of the driverless vehicle to the manual driving mode in response to detecting a pressure value of an object on the steering wheel outputted by the pressure sensor being greater than a preset pressure threshold, when the driverless vehicle is in the autonomous driving mode; or switch the driving mode of the driverless vehicle to the autonomous driving mode in response to not detecting a pressure value of an object on the steering wheel outputted by the pressure sensor being greater than the preset pressure threshold, when the driverless vehicle is in the manual driving mode.

In some embodiments, the processor is configured to: when the driverless vehicle is in the autonomous driving mode, output, in a preset prompt time period, prompt information indicating that the driving mode of the driverless vehicle is to be switched to the manual driving mode in response to detecting the sensing signal outputted by the sensor, and if the sensing signal outputted by the sensor is continuously detected in the prompt time period, switch the driving mode of the driverless vehicle to the manual driving mode; or when the driverless vehicle is in the manual driving mode, output, in a preset prompt time period, prompt information indicating that the driving mode of the driverless vehicle is to be switched to the autonomous driving mode in response to that no sensing signal outputted by the sensor is detected, and if no sensing signal outputted by the sensor is detected in the prompt time period, switch the driving mode of the driverless vehicle to the autonomous driving mode.

In some embodiments, at least two sensors are included in the driverless vehicle, wherein the processor is configured to: switch the driving mode of the driverless vehicle to the manual driving mode in response to detection of sensing signals outputted by the at least two sensors, when the driverless vehicle is in the autonomous driving mode, wherein a distance between the at least two sensors exceeds a predetermined value.

In some embodiments, the processor is configured to: send an autonomous driving mode switching request to a remote service center of the driverless vehicle in response to that sensing signal outputted by the sensor is not detected, when the driverless vehicle is in the manual driving mode; determine whether a permission indicating that switching to the autonomous driving mode can be performed in a current road section is received from the remote service center; and if yes, switch the driving mode of the driverless vehicle to the autonomous driving mode; and if not, output information indicating that the switching to the autonomous driving mode of the driverless vehicle fails.

In some embodiments, the sensor further comprises a distance sensor; and the processor is configured to: output prompt information for preventing an unintended touch in response to detecting a distance value outputted by the distance sensor being smaller than a preset distance threshold, when the driverless vehicle is in the autonomous driving mode.

According to a second aspect, some embodiments of the present application provides a driverless vehicle control method, which comprises: switching a driving mode of a driverless vehicle to a manual driving mode in response to detecting a sensing signal outputted by a sensor, when the driverless vehicle is in an autonomous driving mode, the sensor provided on a steering wheel of the driverless vehicle.

According to a third aspect, some embodiments of the present application provides an driverless vehicle apparatus, which comprises: a detection unit configured to detect a sensor signal outputted by a sensor, wherein the sensor is provided on a steering wheel of the driverless vehicle; and a switching unit configured to switch a driving mode of the driverless vehicle to a manual driving mode in response to detecting the sensor signal, when the driverless vehicle is in an autonomous driving mode.

According to the driverless vehicle provided by some embodiments of the present application, the sensor is provided on the steering wheel of the vehicle, and the driving mode of the driverless vehicle is switched to the manual driving mode in response to detecting a sensing signal outputted by the sensor, when the driverless vehicle is in the autonomous driving mode, thereby achieving smooth switching of the driving mode.

### BRIEF DESCRIPTION OF THE DRAWINGS

Other features, objectives and advantages of the present application will become more apparent upon reading the detailed description to non-limiting embodiments with reference to the accompanying drawings, wherein:

FIG. 1 is an architectural diagram of a system in which some embodiments of the present application may be implemented;

FIG. 2 is a structural diagram of a vehicle according to an embodiment of the present application;

FIG. 3 is a diagram illustrating a spatial relationship between a sensor and a steering wheel according to the corresponding embodiment shown in FIG. 2;

FIG. 4A is a cross-sectional view of a steering wheel provided with a sensor according to the corresponding embodiment shown in FIG. 2;

FIG. 4B is a front view of a steering wheel provided with a sensor according to the corresponding embodiment shown in FIG. 2;

FIG. 4C is a front view of another steering wheel provided with a sensor according to the corresponding embodiment shown in FIG. 2;

FIG. 5 is a diagram illustrating an application scenario of a driverless vehicle according to some embodiments of the present application; and

FIG. 6 is a schematic structural diagram of a driverless vehicle control apparatus according to an embodiment of the present application.

### DETAILED DESCRIPTION

The present application will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present application and the features in the embodiments may be combined with each other on a non-conflict basis. The present application will be described below in detail with reference to the accompanying drawings and in combination with the embodiments.

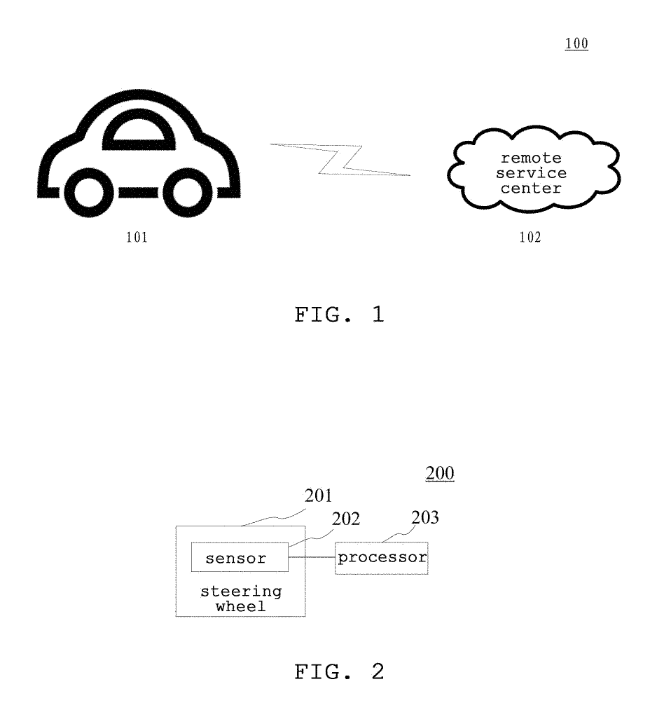

FIG. 1 illustrates a vehicle system architecture 100 in which an embodiment of the present application may be implemented.

As shown in FIG. 1, the vehicle system architecture 100 includes a driverless vehicle 101 and a remote service center 102. The vehicle 101 and the remote service center 102 may be connected to each other through a wireless network.

The vehicle 101 may be driven under the control of an autonomous driving system, or may be driven under the control of a driver. When particular conditions are satisfied, switching between the two driving modes can be performed. When the vehicle is in an autonomous driving mode, data may be exchanged between the vehicle 101 and the remote service center 102 through a network, so as to implement autonomous driving of the vehicle 101. When the vehicle 101 is in a manual driving mode, data may also be exchanged between the vehicle 101 and the remote service center 102.

It should be noted that the vehicle control method provided in the embodiments of the present application may be implemented by components in the vehicle 101 in cooperation, and correspondingly, units of the vehicle control apparatus provided in the embodiments of the present application may also be disposed in the components of the vehicle 101.

Referring to FIG. 2, FIG. 2 is a schematic structural diagram of a driverless vehicle 200 according to an embodiment of the present application.

As shown in FIG. 2, the driverless vehicle 200 may include a steering wheel 201, a sensor 202, and a processor 203. The sensor 202 may be mounted on the steering wheel 201, and the sensor 202 can communicate with the processor 203.

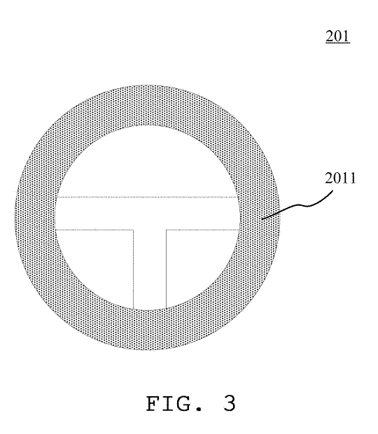

For the manner in which the sensor 202 is mounted on the steering wheel 201, reference can be made to FIG. 3. As shown in FIG. 3, the sensor 202 may be mounted in an annular area 2011 of the steering wheel 201. The sensor 202 may output a sensing signal when detecting an operation such as a touch or press on the steering wheel 201. For example, when a user touches or presses the steering wheel with a hand, the sensor 202 detects a touch or press operation, and outputs a sensing signal.

An operation of an object on the steering wheel 201 that is detected by the sensor 202 may also be other operations that will not affect the traveling status of the vehicle, for example, swiping an area on the steering wheel without turning the steering wheel. In this way, the user can make some actions that can be detected by the sensor 202, without affecting the traveling status of the vehicle 200.

The sensor 202 and the processor 203 may communicate with each other through wireless connection or wired connection, so as to transmit and receive signals. The processor 203 may receive a sensing signal outputted by the sensor 202. When the driverless vehicle is in the autonomous driving mode, the processor 203 switches the driving mode of the driverless vehicle to the manual driving mode in response to receiving the sensing signal outputted by the sensor 202.

In practice, the user may perform a predetermined operation on the steering wheel 201 with a hand. The sensor 202 outputs a sensing signal when detecting the operation. Upon detecting the sensing signal, the processor 203 may generate a control signal for exiting the autonomous driving mode, and switch the vehicle 200 from the autonomous driving mode to the manual driving mode according to the control signal.

In some optional implementations of this embodiment, the above-mentioned processor 203 may be used for: switching the driving mode of the driverless vehicle to the autonomous driving mode in response to that no sensing signal outputted by the sensor is detected, when the driverless vehicle is in the manual driving mode. For example, after the driver removes the hands from the steering wheel, the sensor cannot detect a touch or press operation on the steering wheel, and does not output the sensing signal. The processor 202 switches the driving mode of the driverless vehicle to the autonomous driving mode.

In some optional implementations of this embodiment, the above-mentioned sensor 202 includes at least one of the following: a capacitive sensor, for detecting whether there is an object in contact with the steering wheel, and if yes, outputting a sensing signal indicating that there is an object in contact with the steering wheel; a tactile switch, for detecting whether there is an object pressing the steering wheel, and if yes, outputting a sensing signal indicating that there is an object pressing the steering wheel; a proximity switch, for detecting whether there is an object approaching the steering wheel, and if yes, outputting a sensing signal indicating that there is an object approaching the steering wheel; and a pressure sensor, for detecting whether there is an object pressing the steering wheel, and if yes, outputting a sensing signal indicating that there is an object pressing the steering wheel, and for detecting and outputting magnitude of the pressure of the object on the steering wheel.

The capacitive sensor is a sensing device based on touch operations, and is used for detecting whether a conductive object exists. The conductive object may be, for example, a user's hand. The tactile switch is a mechanical switch, metal contacts of which may be connected after the switch is lightly pressed, so as to generate a sensing signal. The pressure sensor is different from the capacitive sensor in that merely contact cannot cause the pressure sensor to output a sensing signal, and a force needs to be applied in order to cause the pressure sensor to output a sensing signal. The proximity switch is a position switch that can operate without the need to be in direct mechanical contact with a moving part. When an object approaches a sensing surface of the proximity switch to such an extent that the distance therebetween reaches an action distance, the switch can be actuated without requiring mechanical contact or application of a force. The proximity switch may be an inductive switch, a capacitive switch, a Hall switch, an alternating current switch, or a direct current switch.

In some optional implementations of this embodiment, the capacitive sensor includes: an insulated flexible printed circuit board covering an inner surface of an annular body of the steering wheel, and an electrostatic capacitance detecting electrode disposed on a surface of the flexible printed circuit board.

In some optional implementations of this embodiment, the pressure sensor includes: an insulated flexible printed circuit board covering an inner surface of an annular body of the steering wheel, and a pressure sensitive material, such as a piezoelectric ceramic, a piezoelectric film and so on, disposed on a surface of the flexible printed circuit board.

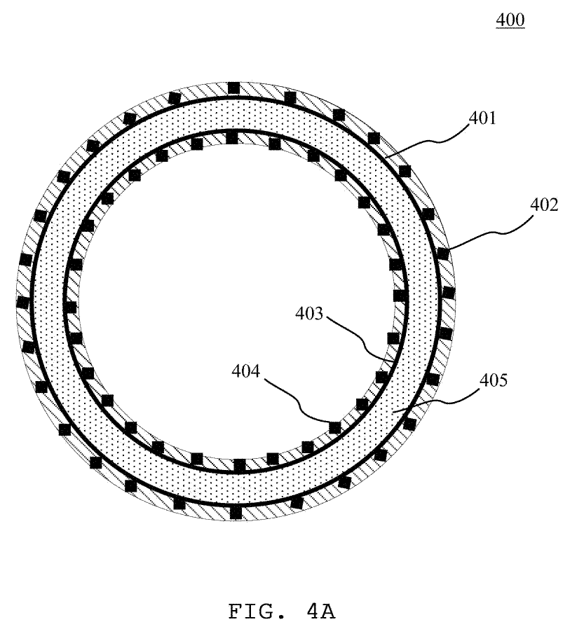

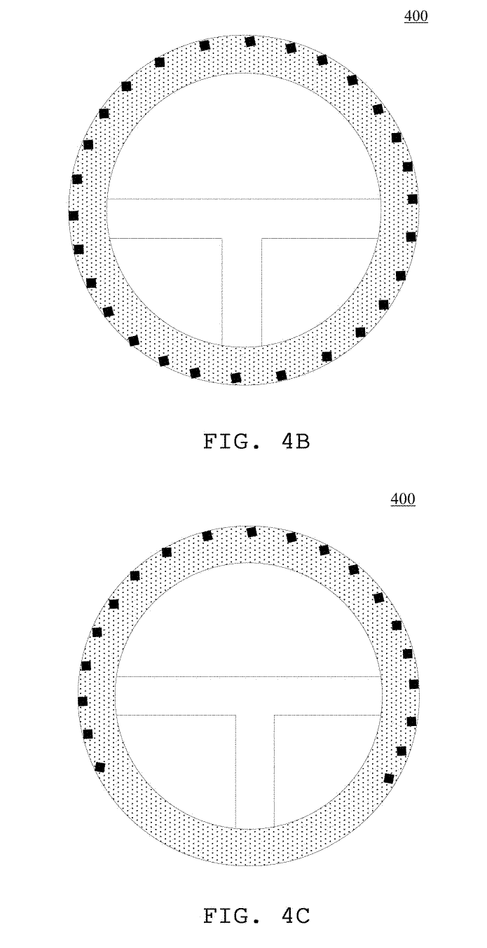

As shown in FIG. 4A, FIG. 4A is a cross-sectional view of an annular body of a steering wheel and a sensor disposed thereon. 401 and 403 denote inner surfaces of the annular body 400. The above-mentioned inner surfaces may each be covered with a flexible printed circuit board. 402 and 404 denote sensors disposed between outer surfaces of the annular body 400 and flexible printed circuit boards covering the above-mentioned inner surfaces. A cavity 405 may be used for passing some circuit lines therethrough, or may be used for placing some insulating fillers therein. It should be noted that the shape, number, and positions of the sensors in FIG. 4 are exemplary, and sensors of different shapes or different numbers of sensors may be selected according to requirements. FIG. 4B is a front view of a steering wheel. As shown in FIG. 4B, sensors may be disposed only on the outer ring of the steering wheel, so as to detect a predetermined operation, or may be further disposed on the inner ring of the steering wheel, so as to prevent switching the driving mode caused by an unintended touch on the steering wheel. FIG. 4C is a front view of a steering wheel. As shown in FIG. 4C, sensors may be disposed only on the upper half of the steering wheel, so as to prevent an unintended touch of the leg on the sensors.

In some optional implementations of this embodiment, when the sensor 202 is a pressure sensor, the processor 203 may be used for: switching the driving mode of the driverless vehicle to the manual driving mode in response to detecting that a pressure value of an object on the steering wheel that is outputted by the pressure sensor being greater than a preset pressure threshold, when the driverless vehicle is in the autonomous driving mode; or switching the driving mode of the driverless vehicle to the autonomous driving mode in response to not detecting a pressure value of an object on the steering wheel that is outputted by the pressure sensor being greater than the preset pressure threshold, when the driverless vehicle is in the manual driving mode. The above-mentioned pressure threshold may be set according to actual requirements, and for example, may be set to a small value, for example, 1 N. Alternatively, the pressure threshold may be acquired by collecting a force used by a user to hold the steering wheel. Alternatively, the pressure sensor may output a sensing signal when detecting that the pressure is greater than the preset threshold. In this manner, not only smooth switching of the driving mode can be ensured, but also switching due to an unintended touch can be effectively avoided, thereby achieving higher reliability.

In some optional implementations of this embodiment, the processor 203 may be used for: outputting, in a preset prompt time period, prompt information indicating that the driving mode of the driverless vehicle is to be switched to the manual driving mode, in response to detecting a sensing signal outputted by the sensor 202 when the driverless vehicle is in the autonomous driving mode, and if the sensing signal outputted by the sensor 202 is continuously detected in the prompt time period, switching the driving mode of the driverless vehicle to the manual driving mode; or outputting, in a preset prompt time period, prompt information indicating that the driving mode of the driverless vehicle is to be switched to the autonomous driving mode, in response to that no sensing signal outputted by the sensor 202 is detected when the driverless vehicle is in the manual driving mode, and if no sensing signal outputted by the sensor 202 is detected in the prompt time period, switching the driving mode of the driverless vehicle to the autonomous driving mode. For example, the above-mentioned preset prompt time period may be three seconds, the prompt information may be image information or voice information, and content of the prompt information may be: switching the driving mode after a three-second countdown.

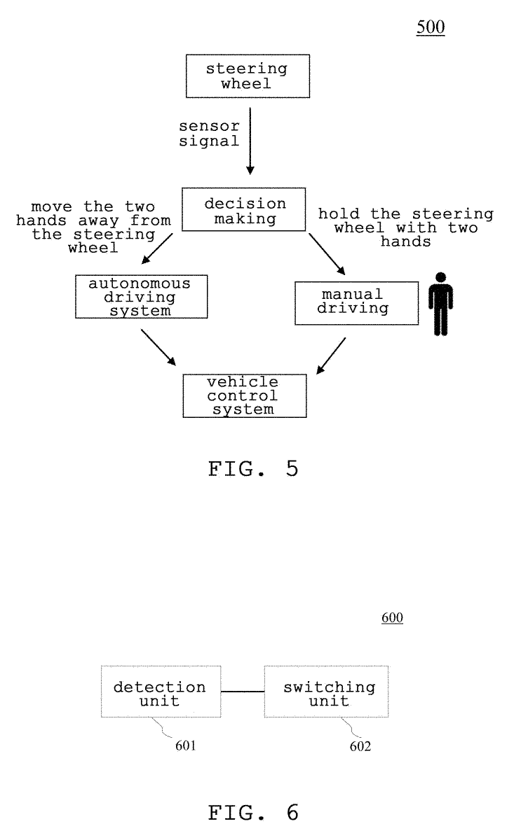

In some optional implementations of this embodiment, the number of the sensors 202 is at least two; and the processor 203 is used for: switching the driving mode of the driverless vehicle to the manual driving mode in response to detecting sensing signals outputted by the at least two sensors, when the driverless vehicle is in the autonomous driving mode, wherein a distance between the at least two sensors exceeds a predetermined value. A condition of switching the driving mode of the driverless vehicle to the manual driving mode may be that the driver touches or presses the steering wheel with two hands. In this case, the number of the sensors 202 needs to be at least two. When there is a small number of sensors, information for indicating positions of the sensors may be provided on the steering wheel, making it convenient for the driver to switch the driving mode. The above-mentioned predetermined value may be the width of a palm of an adult, for example, 6 to 10 cm. As shown in FIG. 5, when the driver intends to switch the vehicle to the manual driving mode, the driver only needs to hold the steering wheel with two hands, a sensing device receives a signal, and a decision making system instructs the autonomous driving system to stop control. When the driver moves the two hands away from the steering wheel, the sensing device detects that the two hands have been moved away from the steering wheel, and the decision making system instructs the autonomous driving system to take control of the vehicle.

In some optional implementations of this embodiment, the processor 203 is used for: sending an autonomous driving mode switching request to a remote service center of the driverless vehicle in response to that no sensing signal outputted by the sensor 202 is detected, when the driverless vehicle is in the manual driving mode; determining whether a permission indicating that switching to the autonomous driving mode can be performed in the current road section is received from the remote service center; and if yes, switching the driving mode of the driverless vehicle to the autonomous driving mode; or if not, outputting information indicating that the switching to the autonomous driving mode of the driverless vehicle fails. Because the autonomous driving function may need to rely on data such as a high precision map provided by the remote service center, it may be determined whether the remote service center has related data of the current road section before the driving mode is switched to autonomous driving. If yes, the driving mode is switched. It is also possible that the autonomous driving mode cannot be used due to reasons such as poor weather conditions or complex rood conditions.

In some optional implementations of this embodiment, the sensor 202 further includes a distance sensor; and the processor 203 is used for: outputting prompt information for preventing an unintended touch in response to detecting that a distance value outputted by the distance sensor being smaller than a preset distance threshold, when the driverless vehicle is in the autonomous driving mode. Likewise, the distance sensor may also output a sensing signal when detecting that a distance between an object and the steering wheel is smaller than the preset distance threshold, and the processor 203 outputs prompt information for preventing an unintended touch in response to the detection of the sensing signal. For example, when there is an object at a distance of 1 cm from the steering wheel, a prompt may be given in a voice or image form: whether the driving mode needs to be switched to the manual driving mode; if not, please keep away from the steering wheel.

It should be appreciated that in FIG. 2, multiple sensors 202 may be disposed, and the processor 203 may be one or more hardware devices, and may be a computer or other programmable device.

According to the driverless vehicle provided by the above-mentioned embodiment of the present application, the sensor is disposed on the steering wheel of the vehicle, and the driving mode of the driverless vehicle is switched to the manual driving mode in response to detecting a sensing signal outputted by the sensor, when the driverless vehicle is in the autonomous driving mode, thereby achieving smooth switching of the driving mode.

A vehicle to which a driverless vehicle control method of some embodiments of the present application is applicable includes a steering wheel and a processor. A sensor is provided on the steering wheel. The sensor may be used for detecting various actions of an object that are associated with the steering wheel. The above-mentioned driverless vehicle control method includes the following steps:

switching a driving mode of a driverless vehicle to a manual driving mode in response to detecting a sensing signal outputted by a sensor, when the driverless vehicle is in an autonomous driving mode.

In this embodiment, the sensor may be mounted in an annular area of the steering wheel. The sensor may output a sensing signal when detecting an operation such as a touch or press on the steering wheel. For example, when a user touches or presses the steering wheel with a hand, the sensor detects a touch or press operation, and outputs a sensing signal. An operation of an object on the steering wheel that is detected by the sensor may also be other operations that will not affect the traveling status of the vehicle, for example, swiping an area on the steering wheel without turning the steering wheel. In this way, the user can make some actions that can be detected by the sensor, without affecting the traveling status of the vehicle.

In some optional implementations of this embodiment, the driving mode of the driverless vehicle may be switched to the autonomous driving mode in response to that no sensing signal outputted by the sensor is detected, when the driverless vehicle is in the manual driving mode. For example, after the driver removes the hand from the steering wheel, the sensor cannot detect a touch or press operation on the steering wheel, and does not output the sensing signal. In this case, the driving mode of the driverless vehicle may be switched to the autonomous driving mode.

In some optional implementations of this embodiment, the above-mentioned sensor includes at least one of the following: a capacitive sensor for detecting a contact between an object and the steering wheel, and outputting a sensing signal indicating the contact between the object and the steering wheel if affirmative; a tactile switch for detecting an object pressing the steering wheel, and outputting a sensing signal indicating the object pressing the steering wheel if affirmative; a proximity switch for detecting an object approaching the steering wheel, and outputting a sensing signal indicating the object approaching the steering wheel if affirmative; and a pressure sensor for detecting an object pressing the steering wheel, outputting a sensing signal indicating the object pressing the steering wheel, and detecting and outputting magnitude of a pressure exerted by the object on the steering wheel if affirmative.

In some optional implementations of this embodiment, the capacitive sensor includes: an insulated flexible printed circuit board covering an inner surface of an annular body of the steering wheel, and an electrostatic capacitance detecting electrode disposed on a surface of the flexible printed circuit board.

In some optional implementations of this embodiment, the pressure sensor includes: an insulated flexible printed circuit board covering an inner surface of an annular body of the steering wheel, and a pressure sensitive material, such as a piezoelectric ceramic, a piezoelectric film and so on, disposed on a surface of the flexible printed circuit board.

In some optional implementations of this embodiment, when the sensor is a pressure sensor, the driving mode of the driverless vehicle may be switched to the manual driving mode in response to detecting a pressure value of an object on the steering wheel that is outputted by the pressure sensor being greater than a preset pressure threshold, when the driverless vehicle is in the autonomous driving mode; or the driving mode of the driverless vehicle may be switched to the autonomous driving mode in response to not detecting a pressure value of an object on the steering wheel that is outputted by the pressure sensor being greater than the preset pressure threshold, when the driverless vehicle is in the manual driving mode. The above-mentioned pressure threshold may be set according to actual requirements, and for example, may be set to a small value, for example, 1 N. Alternatively, the pressure threshold may be acquired by collecting a force used by a user to hold the steering wheel. Alternatively, the pressure sensor may output a sensing signal when detecting that the pressure is greater than the preset threshold. In this manner, not only smooth switching of the driving mode can be ensured, but also switching due to an unintended touch can be effectively avoided, thereby achieving higher reliability.

In some optional implementations of this embodiment, prompt information indicating that the driving mode of the driverless vehicle is to be switched to the manual driving mode may be outputted in a preset prompt time period in response to detecting a sensing signal outputted by the sensor when the driverless vehicle is in the autonomous driving mode, and if the sensing signal outputted by the sensor is continuously detected in the prompt time period, the driving mode of the driverless vehicle is switched to the manual driving mode; or prompt information indicating that the driving mode of the driverless vehicle is to be switched to the autonomous driving mode may be outputted in a preset prompt time period in response to that no sensing signal outputted by the sensor is detected when the driverless vehicle is in the manual driving mode, and if no sensing signal outputted by the sensor is detected in the prompt time period, the driving mode of the driverless vehicle is switched the autonomous driving mode.

In some optional implementations of this embodiment, the number of the sensors is at least two; and the driving mode of the driverless vehicle may be switched to the manual driving mode in response to detecting sensing signals outputted by the at least two sensors, when the driverless vehicle is in the autonomous driving mode, wherein a distance between the at least two sensors exceeds a predetermined value. A condition of switching the driving mode of the driverless vehicle to the manual driving mode may be that the driver touches or presses the steering wheel with two hands. In this case, the number of the sensors needs to be at least two. When there is a small number of sensors, information for indicating positions of the sensors may be provided on the steering wheel, making it convenient for the driver to switch the driving mode. The above-mentioned predetermined value may be the width of a palm of an adult, for example, 6 to 10 cm.

In some optional implementations of this embodiment, an autonomous driving mode switching request may be sent to a remote service center of the driverless vehicle in response to that no sensing signal outputted by the sensor is detected, when the driverless vehicle is in the manual driving mode; it is determined whether a permission indicating that switching to the autonomous driving mode can be performed in the current road section is received from the remote service center; and if yes, the driving mode of the driverless vehicle is switched to the autonomous driving mode; or if not, information indicating that the switching to the autonomous driving mode of the driverless vehicle fails is outputted. Because the autonomous driving function may need to rely on data such as a high precision map provided by the remote service center, it may be determined whether the remote service center has related data of the current road section before the driving mode is switched to autonomous driving. If yes, the driving mode is switched. It is also possible that the autonomous driving mode cannot be used due to reasons such as poor weather conditions or complex rood conditions.

In some optional implementations of this embodiment, the sensor further includes a distance sensor; and prompt information for preventing an unintended touch may be outputted in response to detecting a distance value outputted by the distance sensor being smaller than a preset distance threshold, when the driverless vehicle is in the autonomous driving mode. Likewise, the distance sensor may also output a sensing signal when detecting that a distance between an object and the steering wheel is smaller than the preset distance threshold, and prompt information for preventing an unintended touch is outputted in response to detecting the sensing signal. For example, when there is an object at a distance of 1 cm from the steering wheel, a prompt may be given in a voice or image form: whether the driving mode needs to be switched to the manual driving mode; if not, please keep away from the steering wheel.

According to the method provided in the above-mentioned embodiment of the present application, the driving mode of the driverless vehicle can be switched to the manual driving mode in response to detecting a sensing signal outputted by the sensor when the driverless vehicle is in the autonomous driving mode, thereby achieving smooth switching of the driving mode of the vehicle. For specific processing of this implementation, reference can be made to the corresponding implementation in the embodiment corresponding to FIG. 2.

Further, referring to FIG. 6, as an implementation of the methods shown in the above-mentioned figures, the present application provides one embodiment of a driverless vehicle control apparatus. This apparatus embodiment corresponds to the embodiment of the above-mentioned driverless vehicle control method. The apparatus may be specifically applied to various electronic devices.

As shown in FIG. 6, the vehicle control apparatus 600 of this embodiment includes: a detection unit 601, for detecting a sensing signal outputted by a sensor, wherein the sensor is disposed on a steering wheel of a driverless vehicle; and a switching unit 602, for switching a driving mode of the driverless vehicle to a manual driving mode in response to detecting the sensing signal, when the driverless vehicle is in an autonomous driving mode.

In some optional implementations of this embodiment, the above-mentioned switching unit 602 is further configured to: switch the driving mode of the driverless vehicle to the autonomous driving mode in response to that no sensing signal outputted by the sensor is detected, when the driverless vehicle is in the manual driving mode.

In some optional implementations of this embodiment, the above-mentioned sensor includes at least one of the following: a capacitive sensor for detecting a contact between an object and the steering wheel, and outputting a sensing signal indicating is the contact between an object and the steering wheel if affirmative; a tactile switch for detecting an object pressing the steering wheel, and outputting a sensing signal indicating the object pressing the steering wheel if affirmative; a proximity switch for detecting an object approaching the steering wheel, and outputting a sensing signal indicating the object approaching the steering wheel if affirmative; and a pressure sensor for detecting an object pressing the steering wheel, outputting a sensing signal indicating an object pressing the steering wheel, and detecting and outputting magnitude of a pressure exerted by the object on the steering wheel if affirmative.

In some optional implementations of this embodiment, the above-mentioned capacitive sensor includes: an insulated flexible printed circuit board covering an inner surface of an annular body of the steering wheel, and an electrostatic capacitance detecting electrode disposed on a surface of the flexible printed circuit board.

In some optional implementations of this embodiment, the above-mentioned pressure sensor includes: an insulated flexible printed circuit board covering an inner surface of an annular body of the steering wheel, and a pressure sensitive material disposed on a surface of the flexible printed circuit board.

In some optional implementations of this embodiment, when the above-mentioned sensor is a pressure sensor, the above-mentioned switching unit 602 is further configured to: switch the driving mode of the driverless vehicle to the manual driving mode in response to detecting a pressure value of an object on the steering wheel that is outputted by the pressure sensor being greater than a preset pressure threshold, when the driverless vehicle is in the autonomous driving mode; or switch the driving mode of the driverless vehicle to the autonomous driving mode in response to detecting of that a value of a pressure of an object on the steering wheel that is outputted by the pressure sensor being not greater than the preset pressure threshold, when the driverless vehicle is in the manual driving mode.

In some optional implementations of this embodiment, the above-mentioned switching unit 602 is further configured to: outputting, in a preset prompt time period, prompt information indicating that the driving mode of the driverless vehicle is to be switched to the manual driving mode, in response to detecting a sensing signal outputted by the sensor when the driverless vehicle is in the autonomous driving mode, and if the sensing signal outputted by the sensor is continuously detected in the prompt time period, switch the driving mode of the driverless vehicle to the manual driving mode; or outputting, in a preset prompt time period, prompt information indicating that the driving mode of the driverless vehicle is to be switched to the autonomous driving mode, in response to that no sensing signal outputted by the sensor is detected when the driverless vehicle is in the manual driving mode, and if no sensing signal outputted by the sensor is detected in the prompt time period, switch the driving mode of the driverless vehicle to the autonomous driving mode.

In some optional implementations of this embodiment, the number of the above-mentioned sensors is at least two; and the above-mentioned switching unit 602 is further configured to: switch the driving mode of the driverless vehicle to the manual driving mode in response to detecting sensing signals outputted by the at least two sensors, when the driverless vehicle is in the autonomous driving mode, wherein a distance between then the at least two sensors exceeds a predetermined value.

In some optional implementations of this embodiment, the above-mentioned switching unit 602 is further configured to: send an autonomous driving mode switching request to a remote service center of the driverless vehicle in response to that no sensing signal outputted by the sensor is detected, when the driverless vehicle is in the manual driving mode; determine whether a permission indicating that switching to the autonomous driving mode can be performed in the current road section is received from the remote service center; and if yes, switch the driving mode of the driverless vehicle to the autonomous driving mode; or if not, output information indicating that the switching to the autonomous driving mode of the driverless vehicle fails.

In some optional implementations of this embodiment, the above-mentioned sensor further includes a distance sensor; and the above-mentioned switching unit 602 is further configured to: output prompt information for preventing an unintended touch in response to detecting of that a distance value outputted by the distance sensor being smaller than a preset distance threshold, when the driverless vehicle is in the autonomous driving mode.

It should be noted that the flowcharts and block diagrams in the figures illustrate architectures, functions and operations that may be implemented according to the system, the method and the computer program product of the various embodiments of the present disclosure. In this regard, each block in the flow charts and block diagrams may represent a module, a program segment, or a code portion. The module, the program segment, or the code portion comprises one or more executable instructions for implementing the specified logical function. It should be noted that, in some alternative implementations, the functions denoted by the blocks may occur in a sequence different from the sequences shown in the figures. For example, in practice, two blocks in succession may be executed, depending on the involved functionalities, substantially in parallel, or in a reverse sequence. It should also be noted that, each block in the block diagrams and/or the flow charts and/or a combination of the blocks may be implemented by a dedicated hardware-based system executing specific functions or operations, or by a combination of a dedicated hardware and computer instructions.

The units or modules involved in the embodiments of the present application may be implemented by way of software or hardware. The described units or modules may also be provided in a processor, for example, described as: a processor, comprising a detection unit and a switching unit, where the names of these units or modules are not considered as a limitation to the units or modules. For example, the detection unit may also be described as “a unit for detecting a sensing signal outputted by a sensor”.

In another aspect, some embodiments of the present application further provides a nonvolatile computer readable storage medium. The nonvolatile computer readable storage medium may be the nonvolatile computer readable storage medium included in the apparatus in the above embodiments, or a stand-alone nonvolatile computer readable storage medium which has not been assembled into the apparatus. The nonvolatile computer readable storage medium stores one or more programs. The programs are used by one or more processors to switch a driving mode of the driverless vehicle to a manual driving mode in response to detecting a sensing signal output by a sensor, when the driverless vehicle is in an autonomous driving mode.

The foregoing is a description of some embodiments of the present application and the applied technical principles. It should be appreciated by those skilled in the art that the inventive scope of the present application is not limited to the technical solutions formed by the particular combinations of the above technical features. The inventive scope should also cover other technical solutions formed by any combinations of the above technical features or equivalent features thereof without departing from the concept of the disclosure, such as, technical solutions formed by replacing the features as disclosed in the present application with (but not limited to), technical features with similar functions.

What is claimed is:

1. A driverless vehicle comprising:
a steering wheel;
a processor; and
a sensor provided on the steering wheel; and
the processor configured to switch a driving mode of the driverless vehicle to a manual driving mode in response to detecting a sensing signal output by the sensor, when the driverless vehicle is in an autonomous driving mode.

2. The driverless vehicle according to claim 1, wherein the processor is configured to:
switch the driving mode of the driverless vehicle to the autonomous driving mode in response to that no sensing signal output by the sensor is detected, when the driverless vehicle is in the manual driving mode.

3. The driverless vehicle according to claim 1, wherein the sensor comprises at least one of the following:
a capacitive sensor configured to detect a contact between an object and the steering wheel, and output a sensing signal indicating the contact between the object and the steering wheel if affirmative;
a tactile switch configured to detect an object pressing the steering wheel, and output a sensing signal indicating the object pressing the steering wheel if affirmative;
a proximity switch configured to detect an object approaching the steering wheel, and output a sensing signal indicating the object approaching the steering wheel if affirmative; and
a pressure sensor configured to detect an object pressing the steering wheel, output a sensing signal indicating the object pressing the steering wheel, and detect and output magnitude of a pressure exerted by the object on the steering wheel if affirmative.

4. The driverless vehicle according to claim 3, wherein the capacitive sensor comprises: an insulated flexible printed circuit board covering an inner surface of an annular body of the steering wheel, and an electrostatic capacitance detecting electrode disposed on a surface of the flexible printed circuit board.

5. The driverless vehicle according to claim 3, wherein the pressure sensor comprises: an insulated flexible printed circuit board covering an inner surface of an annular body of the steering wheel, and a pressure sensitive material disposed on a surface of the flexible printed circuit board.

6. The driverless vehicle according to claim 1, wherein when the sensor is a pressure sensor, the processor is configured to:
switch the driving mode of the driverless vehicle to the manual driving mode in response to detecting a pressure value of an object on the steering wheel outputted by the pressure sensor being greater than a preset pressure threshold, when the driverless vehicle is in the autonomous driving mode; or
switch the driving mode of the driverless vehicle to the autonomous driving mode in response to not detecting a pressure value of an object on the steering wheel outputted by the pressure sensor being greater than the preset pressure threshold, when the driverless vehicle is in the manual driving mode.

7. The driverless vehicle according to claim 1, wherein the processor is configured to:
when the driverless vehicle is in the autonomous driving mode, output, in a preset prompt time period, prompt information indicating that the driving mode of the driverless vehicle is to be switched to the manual driving mode in response to detecting the sensing signal outputted by the sensor, and if the sensing signal outputted by the sensor is continuously detected in the prompt time period, switch the driving mode of the driverless vehicle to the manual driving mode; or
when the driverless vehicle is in the manual driving mode, output, in a preset prompt time period, prompt information indicating that the driving mode of the driverless vehicle is to be switched to the autonomous driving mode in response to that no sensing signal outputted by the sensor is detected, and if no sensing signal outputted by the sensor is detected in the prompt time period, switch the driving mode of the driverless vehicle to the autonomous driving mode.

8. The driverless vehicle according to claim 1, further comprising at least two sensors, wherein
the processor is configured to:
switch the driving mode of the driverless vehicle to the manual driving mode in response to detection of sensing signals outputted by the at least two sensors, when the driverless vehicle is in the autonomous driving mode, wherein a distance between the at least two sensors exceeds a predetermined value.

9. The driverless vehicle according to claim 1, wherein the processor is configured to:
send an autonomous driving mode switching request to a remote service center of the driverless vehicle in response to that sensing signal outputted by the sensor is not detected, when the driverless vehicle is in the manual driving mode;
determine whether a permission indicating that switching to the autonomous driving mode can be performed in a current road section is received from the remote service center; and
if yes, switch the driving mode of the driverless vehicle to the autonomous driving mode; and
if not, output information indicating that the switching to the autonomous driving mode of the driverless vehicle fails.

10. The driverless vehicle according to claim 1, wherein the sensor further comprises a distance sensor; and
the processor is configured to:
output prompt information for preventing an unintended touch in response to detecting a distance value outputted by the distance sensor being smaller than a preset distance threshold, when the driverless vehicle is in the autonomous driving mode.

11. A driverless vehicle control apparatus comprising:
at least one processor; and
a memory storing instructions, which when executed by the at least one processor, cause the at least one processor to perform operations, the operations comprising:
detecting a sensor signal outputted by a sensor, wherein the sensor is provided on a steering wheel of the driverless vehicle; and
switching a driving mode of the driverless vehicle to a manual driving mode in response to detecting the sensor signal, when the driverless vehicle is in an autonomous driving mode.

12. The apparatus according to claim 11, wherein the operations further comprises:
switching the driving mode of the driverless vehicle to the autonomous driving mode in response to that no sensing signal output by the sensor is detected, when the driverless vehicle is in the manual driving mode.

13. The apparatus according to claim 11, wherein the sensor comprises at least one of the following:
a capacitive sensor configured to detect a contact between an object and the steering wheel, and output a sensing signal indicating the contact between the object and the steering wheel if affirmative;
a tactile switch configured to detect an object pressing the steering wheel, and output a sensing signal indicating the object pressing the steering wheel if affirmative;
a proximity switch configured to detect an object approaching the steering wheel, and output a sensing signal indicating the object approaching the steering wheel if affirmative; and
a pressure sensor configured to detect an object pressing the steering wheel, output a sensing signal indicating the object pressing the steering wheel, and detect and output magnitude of a pressure exerted by the object on the steering wheel if affirmative.

14. The apparatus according to claim 13, wherein the capacitive sensor comprises: an insulated flexible printed circuit board covering an inner surface of an annular body of the steering wheel, and an electrostatic capacitance detecting electrode disposed on a surface of the flexible printed circuit board.

15. The apparatus according to claim 13, wherein the pressure sensor comprises: an insulated flexible printed circuit board covering an inner surface of an annular body of the steering wheel, and a pressure sensitive material disposed on a surface of the flexible printed circuit board.

16. The apparatus according to claim 11, wherein when the sensor is a pressure sensor, the operations further comprises:
switching the driving mode of the driverless vehicle to the manual driving mode in response to detecting a pressure value of an object on the steering wheel outputted by the pressure sensor being greater than a preset pressure threshold, when the driverless vehicle is in the autonomous driving mode; or
switching the driving mode of the driverless vehicle to the autonomous driving mode in response to not detecting a pressure value of an object on the steering wheel outputted by the pressure sensor being greater than the preset pressure threshold, when the driverless vehicle is in the manual driving mode.

17. The apparatus according to claim 11, wherein the operations further comprises:
when the driverless vehicle is in the autonomous driving mode, outputting, in a preset prompt time period, prompt information indicating that the driving mode of the driverless vehicle is to be switched to the manual driving mode in response to detecting the sensing signal outputted by the sensor, and if the sensing signal outputted by the sensor is continuously detected in the prompt time period, switching the driving mode of the driverless vehicle to the manual driving mode; or
when the driverless vehicle is in the manual driving mode, outputting, in a preset prompt time period, prompt information indicating that the driving mode of the driverless vehicle is to be switched to the autonomous driving mode in response to that no sensing signal outputted by the sensor is detected, and if no sensing signal outputted by the sensor is detected in the prompt time period, switching the driving mode of the driverless vehicle to the autonomous driving mode.

18. The apparatus according to claim 11, wherein at least two sensors are provided on the steering wheel of the driverless vehicle, and the operations further comprises:
switching the driving mode of the driverless vehicle to the manual driving mode in response to detection of sensing signals outputted by the at least two sensors, when the driverless vehicle is in the autonomous driving mode, wherein a distance between the at least two sensors exceeds a predetermined value.

19. The apparatus according to claim 11, wherein the operations further comprises:
sending an autonomous driving mode switching request to a remote service center of the driverless vehicle in response to that sensing signal outputted by the sensor is not detected, when the driverless vehicle is in the manual driving mode;
determining whether a permission indicating that switching to the autonomous driving mode can be performed in a current road section is received from the remote service center; and
if yes, switching the driving mode of the driverless vehicle to the autonomous driving mode; and
if not, outputting information indicating that the switching to the autonomous driving mode of the driverless vehicle fails.

20. The apparatus according to claim 11, wherein the sensor further comprises a distance sensor, and the operations further comprises:
outputting prompt information for preventing an unintended touch in response to detecting a distance value outputted by the distance sensor being smaller than a preset distance threshold, when the driverless vehicle is in the autonomous driving mode.

21. A non-transitory storage medium storing one or more programs, the one or more programs when executed by an apparatus, causing the apparatus to perform a driverless vehicle control method, comprising:
switching a driving mode of a driverless vehicle to a manual driving mode in response to detecting a sensing signal outputted by a sensor, when the driverless vehicle is in an autonomous driving mode, the sensor provided on a steering wheel of the driverless vehicle.
